(19) United States
(12) Patent Application Publication
(10) Pub. No.: US 2019/0122421 A1
(43) Pub. Date: Apr. 25, 2019

(54) BATCH RENDERING METHOD, DEVICE, AND APPARATUS

(71) Applicant: Alibaba Group Holding Limited, George Town (KY)

(72) Inventors: Decai Jin, Hangzhou (CN); Xu Zeng, Shanghai (CN); Qinghe Xu, Shanghai (CN)

(21) Appl. No.: 16/053,375

(22) Filed: Aug. 2, 2018

Related U.S. Application Data
(63) Continuation-in-part of application No. PCT/CN17/72403, filed on Jan. 24, 2017.

(30) Foreign Application Priority Data
Feb. 5, 2016 (CN) 201610083256.2

(51) Int. Cl. G06T 15/30

(52) U.S. Cl. CPC G06T 15/30; G06T 2210/12

(57) ABSTRACT

Embodiments of the present application disclose a method, device, and system for batch rendering. The method includes obtaining a plurality of graphic objects associated with a data frame that is to be rendered, determining whether individual graphic objects in the plurality of graphic objects are outside a visible area of a screen to be displayed, and rendering graphic objects of the plurality of graphic objects that are determined to be at least partially within the visible area of the screen, and excluding from rendering graphic objects of the plurality of graphic objects that are determined to be outside the visible area of the screen.

### CROSS REFERENCE TO OTHER APPLICATIONS

This application is a continuation-in-part of and claims priority to International (PCT) Application No. PCT/CN2017/72403 entitled BATCH RENDERING METHOD, DEVICE, AND APPARATUS, filed Jan. 24, 2017 which is incorporated herein by reference for all purposes, which claims priority to China Application No. 201610083256.2 entitled A METHOD, MEANS, AND DEVICE FOR IMPLEMENTING BATCH RENDERING, filed Feb. 5, 2016 which is incorporated herein by reference for all purposes.

### FIELD OF THE INVENTION

The present invention relates to a field of applied computer technology. In particular, the present application relates to a method, system, and device for implementing batch rendering of graphical objects.

### BACKGROUND OF THE INVENTION

Batch rendering technology is currently used by a great majority of graphic engines and graphic frameworks. The basic principle of batch rendering technology includes placing some graphic objects that have the same render state (e.g., color rendering states, fill states, shading states, etc.) into a batch rendering object (generally referred to as a “batch”) and thereafter submitting the batch (e.g., the graphic objects included in the batch rendering object) in one submission to a graphics processing unit (GPU) for rendering. Submission of the graphic objects in a collective batch rendering object allows the central processing unit (CPU) to execute a single submission for processing the graphic objects in connection with the rendering of the graphic objects, and thus the load of the CPU is reduced. Similarly, the load of the GPU is reduced because the GPU is not required to switch multiple times between rendering states (e.g., the GPU can process graphic objects having the same render state without switching rendering states).

However, in connection with rendering one frame of data, conventional batch processing implemented by graphic engines, graphic frameworks, etc. places into a batch all the graphic objects that have the same render state in the operating interface of the system. The graphic objects included in the batch are transferred into a display memory, and rendered. According to conventional batch processing, the steps of putting all the graphic objects that have the same render state into a batch and then transferring the batch (e.g., the corresponding graphic objects in the batch) into display memory for rendering use a significant portion of the processing resources of the CPU, display memory, and the GPU.

In view of the above, there is a need for an implementation of batch processing that can efficiently process corresponding graphic objects.

### BRIEF DESCRIPTION OF THE DRAWINGS

Various embodiments of the invention are disclosed in the following detailed description and the accompanying drawings.

FIG. 1 is a flowchart of a method for batch processing according to various embodiments of the present application.

FIG. 2 is a diagram of a mapping of a bounding box in relation to a graphic object according to various embodiments of the present application.

FIGS. 3A through 3C are diagrams of a relationship between a bounding box and a coordinate region of a screen according to various embodiments of the present application.

FIG. 4 is a diagram of maximum coordinates and minimum coordinates of a graphic object according to various embodiments of the present application.

FIG. 5 is a flowchart of a method for batch processing according to various embodiments of the present application.

FIG. 6 is a structural diagram of a device according to various embodiments of the present application.

FIG. 7 is a functional diagram of a computer system for batch processing according to various embodiments of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In order to further clarify the goals, technical schemes, and advantages of the present invention, the present invention is described in detail below in light of the drawings and specific embodiments.

The terms used in embodiments of the present invention merely serve to describe specific embodiments and are not intended to restrict the present invention. “A,” “said,” and “the” or “this” as used in their singular form in embodiments of the present invention and the claims also are intended to encompass the plural form, unless otherwise clearly indicated by the context.

Please note that the term “and/or” used herein is merely a relationship describing related objects. It may indicate three kinds of relationships. For example, A and/or B may indicate the three situations of: only A exists, A and B both exist, and only B exists. In addition, the symbol “/” herein generally expresses an “or” relationship between the preceding and following objects.

Depending on context, the word “if” when used herein may be interpreted as “when” or “upon” or “in response to the determination that” or “in response to the detection of” Depending on the context, the phrase “upon determining” or “upon detecting (a stated condition or event)” may be understood “when it is determined” or “in response to the determination that” or “upon detecting (a stated condition or event)” or “in response to the detection of (a stated condition or event).”

As used herein, a terminal generally refers to a device comprising one or more processors. A terminal can be a device used (e.g., by a user) within a network system and used to communicate with one or more servers. According to various embodiments of the present disclosure, a terminal includes components that support communication functionality. For example, a terminal can be a smart phone, a server, a machine of shared power banks, information centers (such as one or more services providing information such as traffic or weather, etc.), a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HIVID), electronic clothes, electronic braces, an electronic necklace, an electronic accessory, an electronic tattoo, or a smart watch), a kiosk such as a vending machine, a smart home appliance, vehicle-mounted mobile stations, or the like. A terminal can run various operating systems.

As used herein, a data frame can comprise a page or the like to be displayed by a display unit of the terminal. For example, the data frame is displayed on the screen of the terminal. The data frame can comprise a video frame, a graphical user interface, a home page of an operating system of the terminal, a page of an application running on the terminal (e.g., an application operating in the foreground of the terminal), etc. As an example, a data frame is any frame that is provided to the users on a display device.

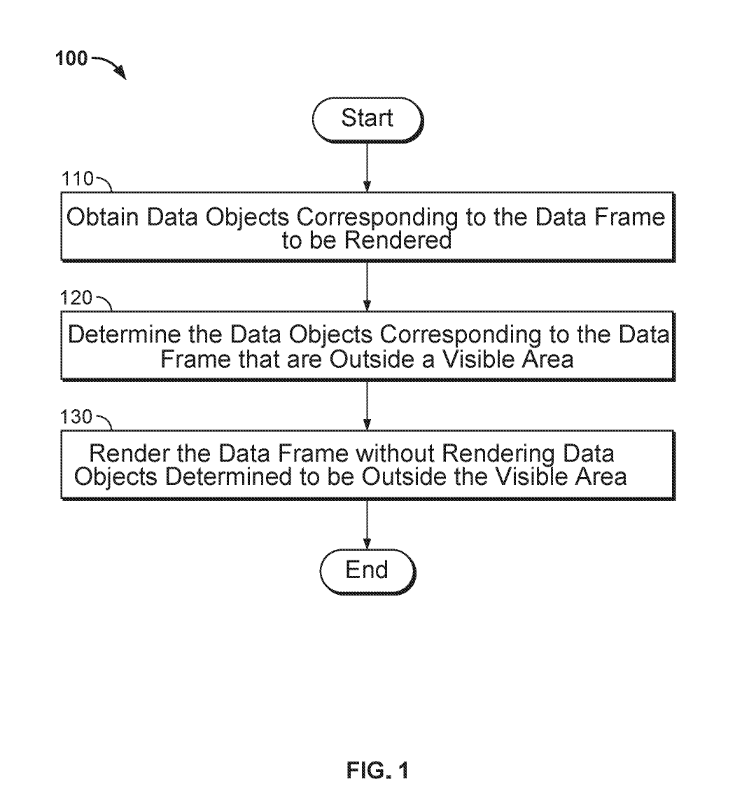

FIG. 1 is a flowchart of a method for batch processing according to various embodiments of the present application.

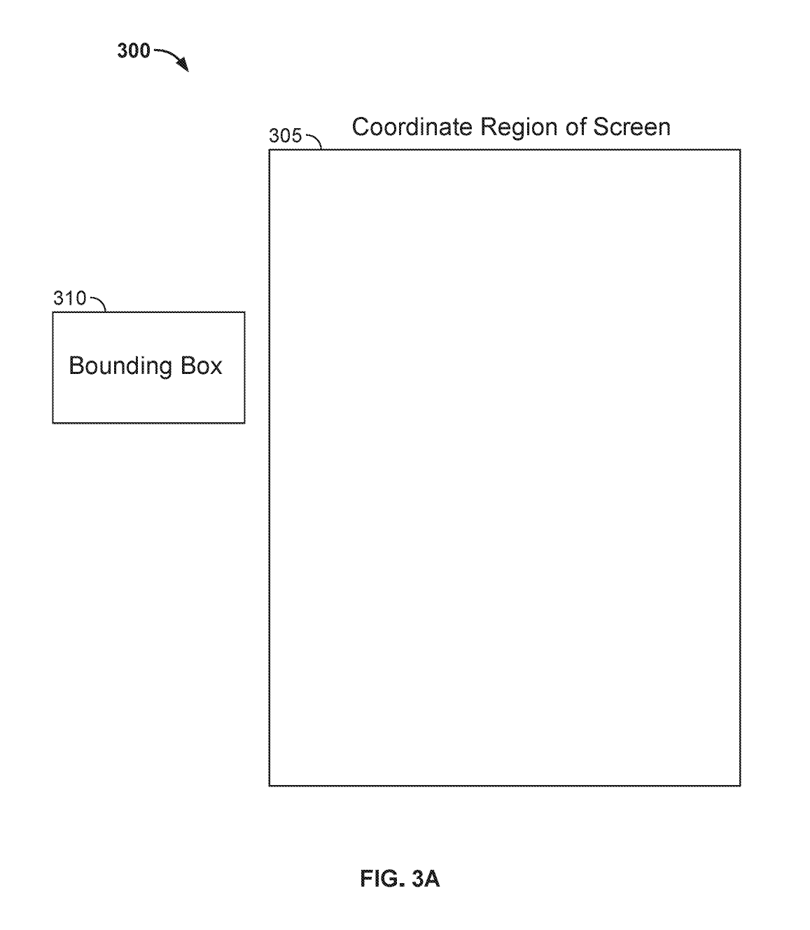

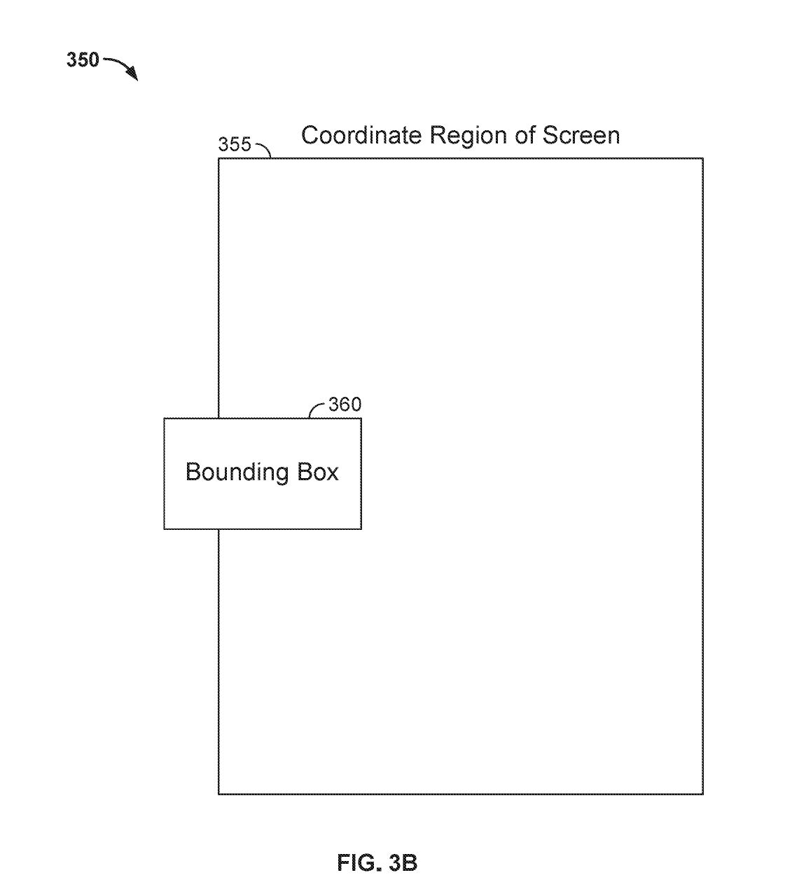

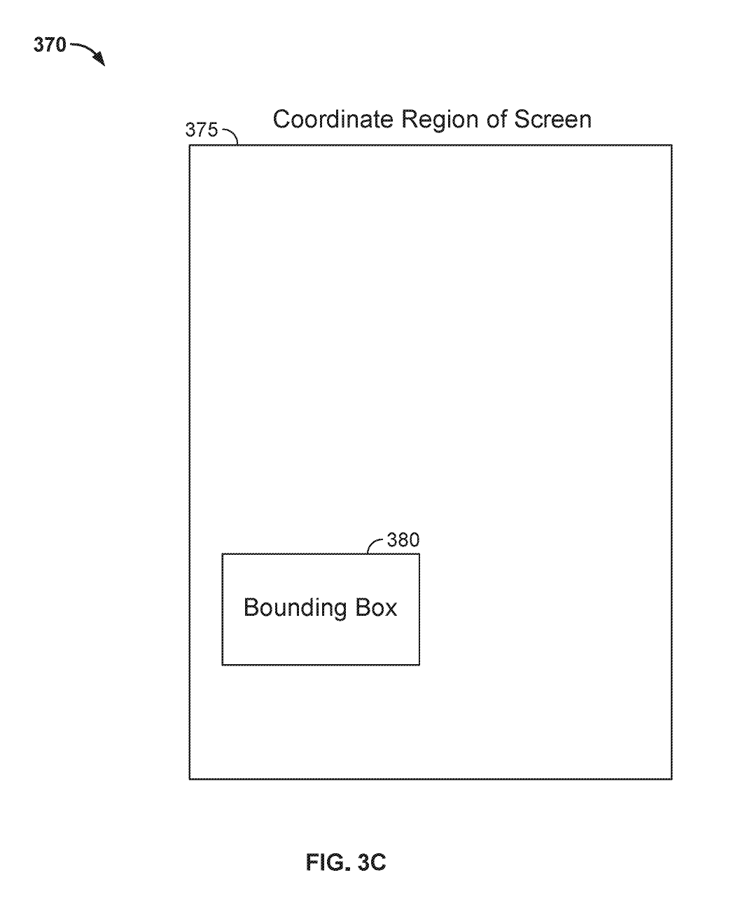

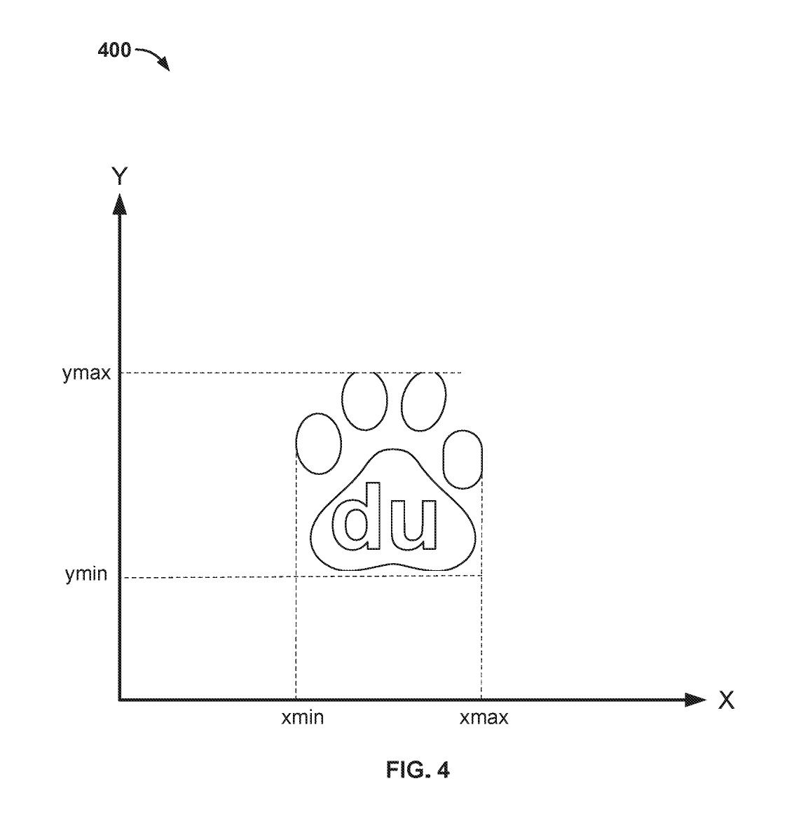

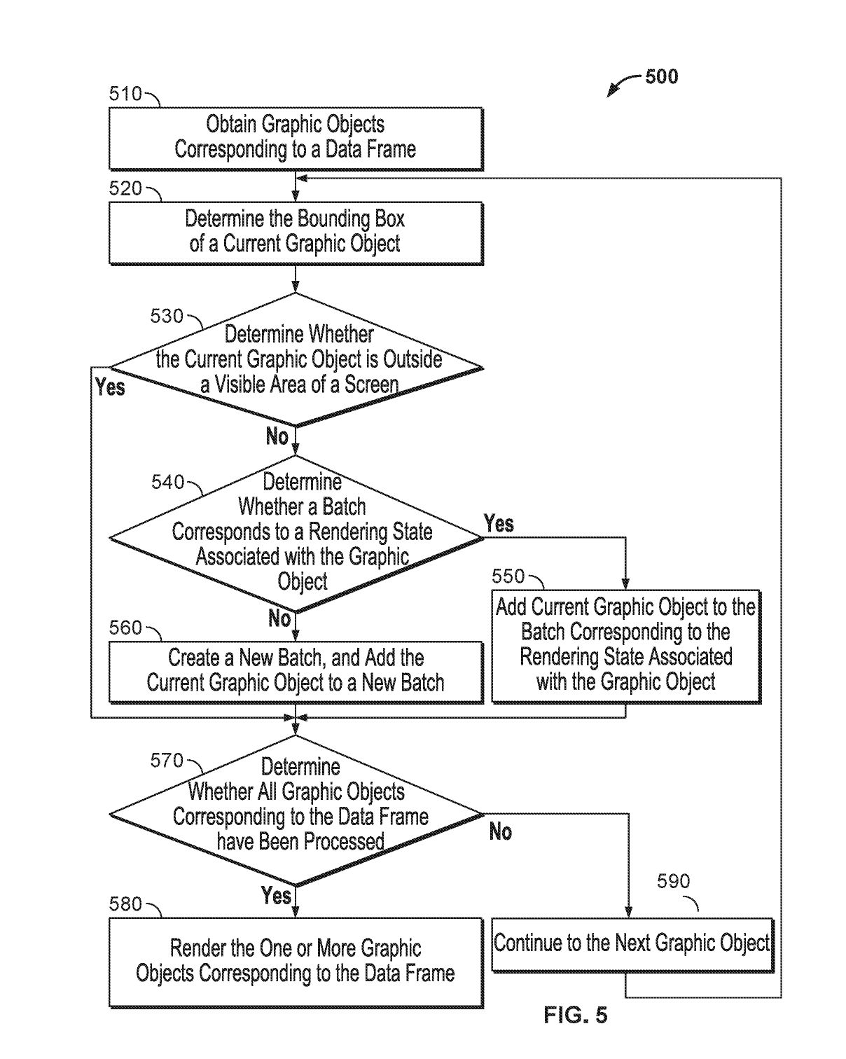

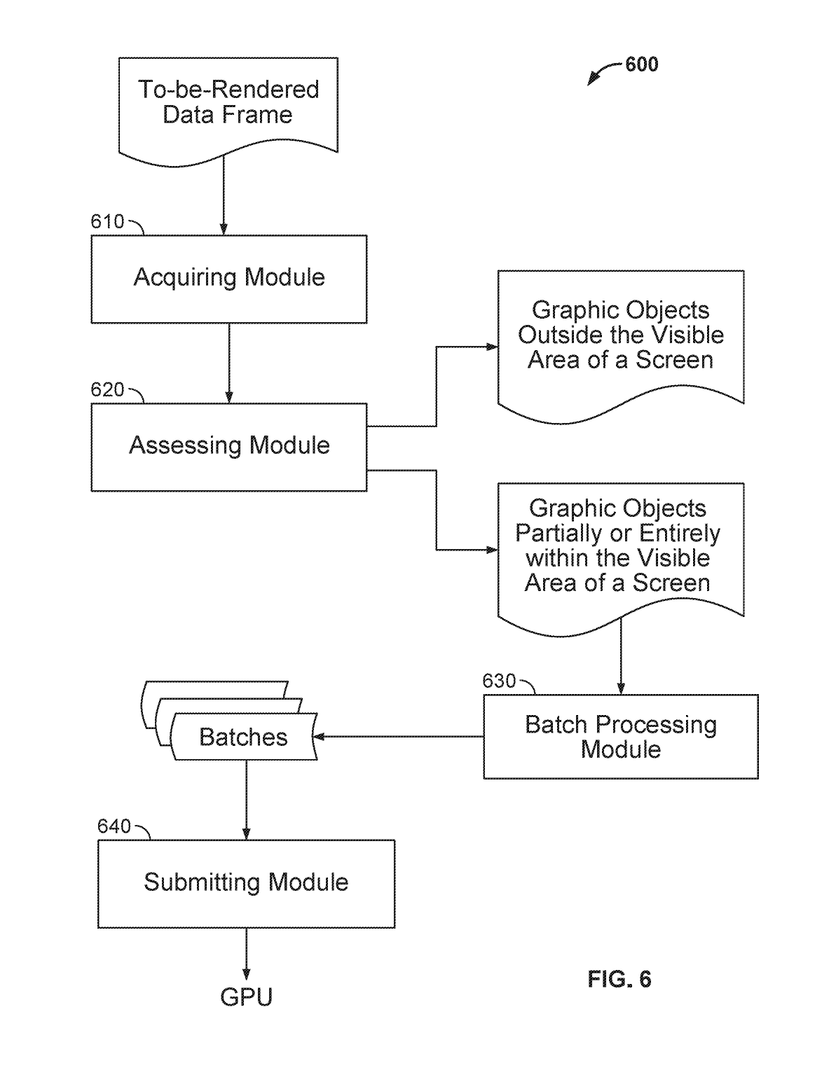

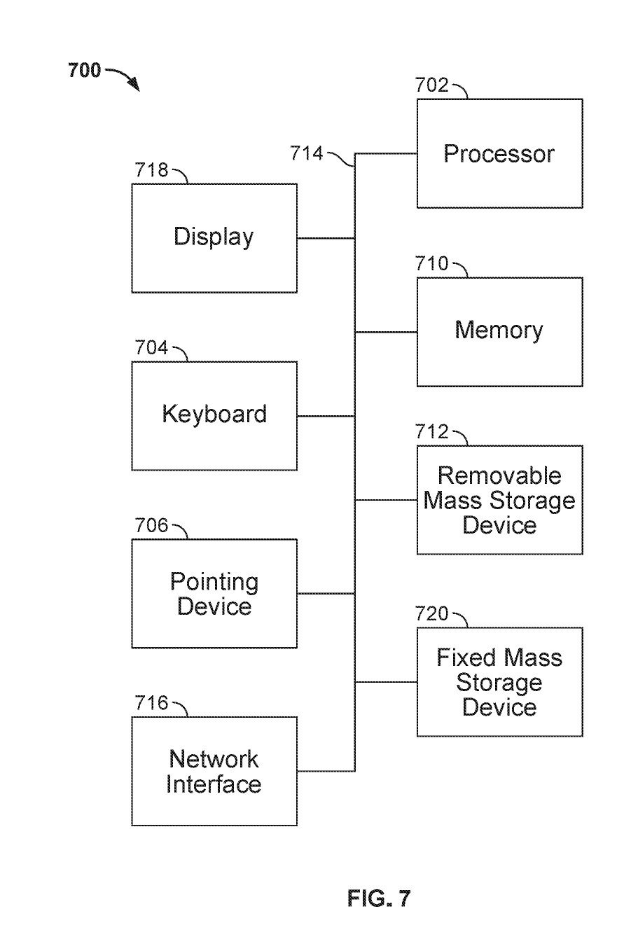

Referring to FIG. 1, process 100 for batch processing is provided. Process 100 can be implemented in connection with mapping 200 of a bounding box, relationship 300 of FIG. 3A, relationship 350 of FIG. 3B, relationship 370 of FIG. 3C, and/or graphic object 400 of FIG. 4. Process 100 can be implemented in connection with process 500 of FIG. 5. Process 100 can be implemented at least in part by device 600 of FIG. 6 and/or computer system 700 of FIG. 7.

According to various embodiments, process 100 is implemented by a terminal. For example, process 100 can be implemented in connection with a terminal rendering or more graphic objects.

At 110, data objects corresponding to a data frame are obtained. In some embodiments, the data objects corresponding to a data frame to be rendered are obtained. As an example, all the graphic objects corresponding to (e.g., to be included in) the data frame to be rendered are obtained. The data objects that are obtained can correspond to one or more graphic objects corresponding to the data frame to be rendered. For example, one or more data objects obtained in connection with the data frame to be rendered correspond to one or more image files. Data objects can be organized by meshes/triangles, and contain vertex position data, color data, material data, texture data, etc. A program (e.g., program code) generally knows all of its corresponding data objects in any data frame. The unit may be different in different level: for an application, the unit can be an object, for an engine, the unit can be is mesh or triangle, for hardware, the unit can be a vertex.

A data frame that is to be rendered can comprise a plurality of image files. For example, a user interface that is to be rendered comprises one or more icons. Each of the one or more icons can correspond to an image file. The obtaining of the data objects corresponding to the data frame to be rendered can comprise obtaining one or more image files from the data frame that is to be rendered.

According to various embodiments, the data objects (e.g., the graphic objects) in a to-be-rendered data frame include graphic data and rendering states. For example, the one or more data objects corresponding to the data frame to be rendered comprise graphic data and a render state. According to various embodiments, graphic data includes vertex coordinates, vertex normal, vertex color, texture coordinates, etc. The graphics data can be represented in float point values. According to various embodiments, rendering states include, but are not limited to, color rendering states, fill states, anti-aliasing states, texture perspective states, shading states, fog states, and smoothness states. Various other rendering states can be implemented.

According to various embodiments, 120 is performed for each data object (e.g., graphic object) corresponding to the data frame to be rendered (e.g., that is obtained at 110).

At 120, one or more data objects that correspond to the data frame and that are outside a visible area are determined. As an example, the CPU determines the one or more data objects that correspond to the data frame and that are outside the visible area. In some embodiments, the terminal determines the one or more objects of the frame to be rendered that are at least in part or wholly outside a visible area. The location information can be obtained based at least in part the vertex coordinates corresponding to the one or more objects of the frame. For example, each graphic object corresponding to a data frame has corresponding vertex coordinates. Each of the obtained graphic objects can be analyzed in connection with determining whether the graphic object is outside the visible area. In some embodiments, a subset of the data objects corresponding to the data frame to be rendered that are obtained at 110 is analyzed to determine whether the corresponding data objects are outside the visible area.

In some embodiments, the visible area corresponds to an area of a display (e.g., a page, an interface, a data frame to be rendered, etc.) that is to be displayed on the screen. A data object (e.g., a graphic object) can be deemed to be outside the visible area if the data object would not appear on the screen if the corresponding data frame were to be rendered. As an example, a data object (e.g., a graphic object) is determined to be outside the visible area if an entire portion of the data object would not appear on the screen if the corresponding data frame were to be rendered. As another example, a data object (e.g., a graphic object) is determined to be outside the visible area if a portion of the data object exceeding a predefined threshold would not appear on the screen if the corresponding data frame were to be rendered. The distance between the data object and the predefined part of the screen can be measured from a predefined part of the data object (e.g., a closest edge, a center part, a part of the data object that is furthest from the predefined part of the screen, etc.).

The determining whether a graphic object is outside a visible area can be implemented according to various approaches. Two approaches for determining whether the graphic object is outside the visible area are described below. However, other implementations are possible.

First approach: the determining whether the graphic object is outside a visible area comprises determining that a bounding box corresponding to the graphic object is outside the visible area of a screen. The terminal can determine the bounding box corresponding to the graphic object, and use the bounding box in connection with determining whether the graphic object is outside the visible area of a screen.

The bounding box of a graphic object can be determined based at least in part on the graphic data comprised in the graphic object. The determining of a bounding box corresponding to a graphic object comprises using a slightly larger geometric figure that has simple characteristics to provide an approximate substitute for a complex geometric object. For example, the bounding box is determined according to a predetermined shape, and the size of the predetermined shape is determined based at least in part on the size of the corresponding graphic object. The bounding box entirely encompasses the region of the graphic object. According to various embodiments, shapes of the bounding box can include, without limitation, bounding rectangles, bounding circles, and bounding triangles. Other shapes can be used for a bounding box. Bounding cubes or bounding spheres can be used for three-dimensional space.

According to various embodiments, the bounding box is determined to be a box (or other predetermined shape) having a minimum size while encompassing the corresponding graphic object. The terminal can determine one or more dimensions of the graphic object in connection with determining the corresponding bounding box. For example, the terminal can determine a height (e.g., length) and width of the graphic object.

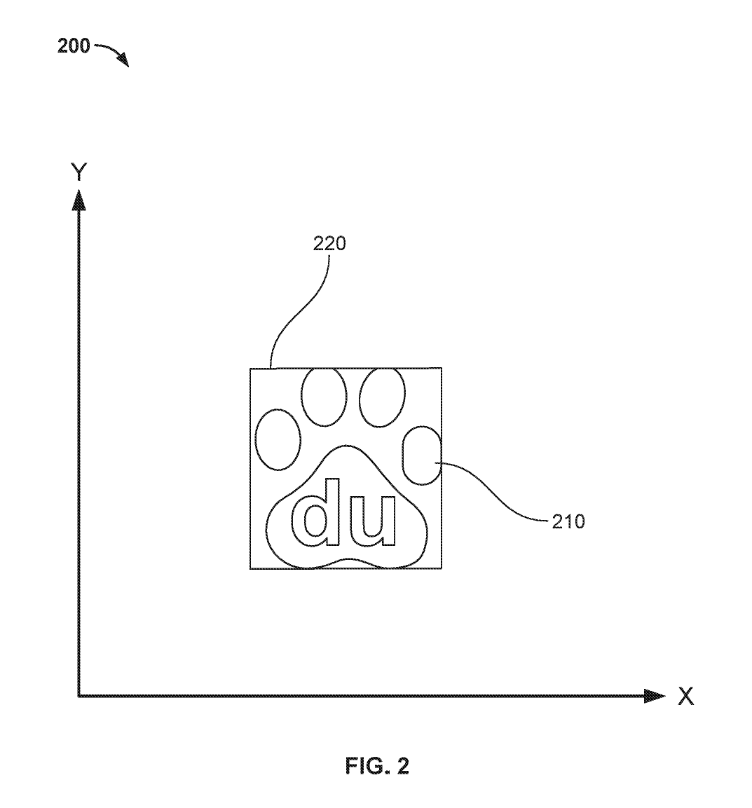

According to various embodiments, graphic objects are expressed in a geometric space coordinate system or can be mapped to a geometric space coordinate system based on information pertaining to the graphic object (e.g., a size, a shape, a location, etc.). As an example of a bounding rectangle in the coordinate system of a geometric space, the left and right sides of the rectangle are parallel to the y-axis, and the top and bottom sides are parallel to the x-axis. The bounding rectangle can take the form of a minimum bounding rectangle for a graphic object. FIG. 2 illustrates an example of a bounding box for a graphic object (e.g., a graphic object having an irregular geometric figure).

FIG. 2 is a diagram of a mapping of a bounding box in relation to a graphic object according to various embodiments of the present application.

Referring to FIG. 2, mapping 200 of a bounding box in relation to a graphic object is provided. Mapping 200 can be implemented in connection with relationship 300 of FIG. 3A, relationship 350 of FIG. 3B, relationship 370 of FIG. 3C, and/or graphic object 400 of FIG. 4. Mapping 200 can be implemented in connection with process 100 of FIG. 1 and/or process 500 of FIG. 5. Mapping 200 can be implemented at least in part by device 600 of FIG. 6 and/or computer system 700 of FIG. 7.

As illustrated in FIG. 2, a bounding box 220 is determined in relation to graphic object 210. Graphic object 210 can be an irregular geometric figure. According to various embodiments, bounding box 220 is determined to be a smallest simple shape (e.g., regular geometric shape such as a square, a circle, a rectangle, etc.) that encompasses an entire corresponding graphic object 210. Bounding box 220 can be a predetermined shape and can be determined to be a corresponding shape, the dimensions of which are determined to be the minimal dimensions necessary for the graphic object 210 to be encompassed by the predetermined shape.

Bounding box 220 as illustrated in FIG. 2 is a rectangle. However, bounding box 220 can correspond to a different shape. In some embodiments, the shape of bounding box 220 is determined based at least in part on the corresponding graphic object. For example, the shape of bounding box 220 can be determined based at least in part on dimensions of the graphic object or a shape of the graphic object (e.g., a shape of bounding box 220 can correspond to a shape that best-fits the graphic object). In some embodiments, the shape of bounding box 220 is predetermined.

Graphic object 210 can correspond to at least one of the data objects obtained at 110 of FIG. 1 in connection with the data frame to be rendered.

Returning to the determining of whether the graphic object is outside a visible area, and specifically the first approach of determining whether the graphic object is outside the visible area discussed above in connection with FIG. 1, a mapping of the bounding box 220 to a space comprising the screen to be displayed is determined. For example, the coordinates of the bounding box corresponding to the graphic object (e.g., bounding box 220 corresponding to graphic object 210) in geometric space are mapped to the pixel space coordinates of a screen. The terminal can determine whether any of the pixels of the bounding box falls within the coordinate region of the screen (e.g., whether any portion of the bounding box overlaps with the screen). In some embodiments, if none of the mapped bounding box coordinates falls within the coordinate region of the screen, the graphic object is determined to be outside of the visible area of the screen. In some embodiments, if any of the mapped bounding box coordinates falls within the coordinate region of the screen, the graphic object is determined to be outside of the visible area of the screen.

FIGS. 3A through 3C are diagrams of a relationship between a bounding box and a coordinate region of a screen according to various embodiments of the present application.

Referring to FIG. 3A, relationship 300 between a bounding box and coordinate region of a screen is provided. Relationship 300 can be determined in connection with mapping 200 of a bounding box, and/or graphic object 400 of FIG. 4. Relationship 300 can be determined at least in part in connection with process 100 of FIG. 1 and/or process 500 of FIG. 5. Relationship 300 can be determined at least in part by device 600 of FIG. 6 and/or computer system 700 of FIG. 7.

As illustrated in FIG. 3A, bounding box 310 is outside the coordinate region of a screen 305. The terminal can determine that the bounding box 310 is outside the coordinate region of the screen 305. According to various embodiments, the coordinate region of the screen 305 corresponds to the visible area of the screen. For example, the terminal can determine that no portion of bounding box 310 is within (e.g., overlaps) the coordinate region of the screen 305. The terminal can determine that the bounding box 310 (e.g., corresponding to a graphic object) is outside the coordinate region of the screen 305 based at least in part on comparing one or more coordinates of the bounding box 310 to one or more coordinates of the coordinate region of the screen 305. In response to determining that the bounding box 310 is outside the coordinate region of the screen 305, the graphic object corresponding to the bounding box 310 can be deemed to be outside the visible area. The terminal (e.g., the GPU) can render a data frame to be displayed on the screen without rendering the graphic object of the data frame that is not within the visible area of the screen. For example, the terminal can exclude one or more graphic objects that are not within the visible area of the screen from rendering or batch processing (e.g., for so long as the graphic object is not within the visible area of the screen).

As shown in FIG. 3A, if coordinates of mapped bounding box 310 entirely fail to intersect with the coordinate region of the screen 305, then the graphic object corresponding to mapped bounding box 310 is determined to be outside the visible area of the screen 305.

Referring to FIG. 3B, relationship 350 between a bounding box and a coordinate region of a screen is provided. Relationship 350 can be determined in connection with mapping 200 of a bounding box, and/or graphic object 400 of FIG. 4. Relationship 350 can be determined at least in part in connection with process 100 of FIG. 1 and/or process 500 of FIG. 5. Relationship 350 can be determined at least in part by device 600 of FIG. 6 and/or computer system 700 of FIG. 7.

As illustrated in FIG. 3B, bounding box 360 is at least partially outside (or conversely partially within) the coordinate region of a screen 355. The terminal can determine that the bounding box 360 is partly outside (or equivalently, partially within) the coordinate region of the screen 355. According to various embodiments, the coordinate region of the screen 355 corresponds to the visible area of the screen. For example, the terminal can determine that a portion of bounding box 360 is within (e.g., overlaps) the coordinate region of the screen 355. The terminal can determine that the bounding box 360 (e.g., corresponding to a graphic object) is at least partially outside (e.g., partially within) the coordinate region of the screen 355 based at least in part on comparing one or more coordinates of the bounding box 360 to one or more coordinates of the coordinate region of the screen 355. For example, the bounding box 360 (and the corresponding graphic object) can be deemed to be at least partially outside the coordinate region of the screen 355 if at least one coordinate corresponding to the bounding box 360 is outside (e.g., does not overlap with) the coordinate region of the screen 355. As another example, the bounding box 360 (and the corresponding graphic object) can be deemed to be partially within the coordinate region of the screen 355 if at least one coordinate corresponding to the bounding box 360 is within (e.g., overlaps with) the coordinate region of the screen 355, and at least one coordinate corresponding to the bounding box 360 is outside (e.g., does not overlap with) the coordinate region of the screen 355. In response to determining that the bounding box 360 is partially outside the coordinate region of the screen 355, the graphic object corresponding to the bounding box 360 can be deemed to be within the visible area. The terminal (e.g., the GPU) can render a data frame to be displayed on the screen including rendering the graphic object of the data frame that is partially within the visible area of the screen. For example, the terminal can include one or more graphic objects that are partially within (e.g., at least partially within) the visible area of the screen and exclude one or more graphic objects that are not within the visible area of the screen from rendering or batch processing (e.g., for so long as the graphic object is not within the visible area of the screen).

As shown in FIG. 3B, if coordinates of mapped bounding box 360 partially intersect with the coordinate region of the screen 355, then the graphic object corresponding to mapped bounding box 360 is determined to be partially within the visible area of the screen 355. In some embodiments, if the mapped bounding box corresponding to the graphic object at least partially intersects (e.g., overlaps with) the coordinate region of the screen, then the graphic object is rendered in connection with the rendering of the data frame with which the graphic object is associated (e.g., the data frame from which the graphic object is obtained). For example, the graphic object is rendered as part of the rendering of the data frame with which the graphic object is associated.

Referring to FIG. 3C, relationship 370 between a bounding box and coordinate region of a screen is provided. Relationship 370 can be determined in connection with mapping 200 of a bounding box, and/or graphic object 400 of FIG. 4. Relationship 370 can be determined at least in part in connection with process 100 of FIG. 1 and/or process 500 of FIG. 5. Relationship 370 can be determined at least in part by device 600 of FIG. 6 and/or computer system 700 of FIG. 7.

As illustrated in FIG. 3C, bounding box 380 is within (e.g., entirely within) the coordinate region of a screen 375. The terminal can determine that the bounding box 380 is within the coordinate region of the screen 375. According to various embodiments, the coordinate region of the screen 375 corresponds to the visible area of the screen. For example, the terminal can determine that a subset of bounding box 380 is entirely within (e.g., overlaps) the coordinate region of the screen 375. The terminal can determine that the bounding box 380 (e.g., corresponding to a graphic object) is within the coordinate region of the screen 375 based at least in part on comparing one or more coordinates of the bounding box 380 to one or more coordinates of the coordinate region of the screen 375. For example, the bounding box 380 (and the corresponding graphic object) can be deemed to be within (e.g., entirely within) the coordinate region of the screen 375 if all the coordinates corresponding to the bounding box 380 are inside (e.g., overlap with) the coordinate region of the screen 375. In response to determining that the bounding box 380 is within the coordinate region of the screen 375, the graphic object corresponding to the bounding box 380 can be deemed to be within the visible area. The terminal (e.g., the GPU) can render a data frame to be displayed on the screen including rendering the graphic object of the data frame that is within the visible area of the screen.

As shown in FIG. 3C, if coordinates of mapped bounding box 380 entirely intersect with the coordinate region of the screen 375, then the graphic object corresponding to mapped bounding box 380 is determined to be within (e.g., entirely within) the visible area of the screen 375. In some embodiments, if the mapped bounding box corresponding to the graphic object entirely intersects (e.g., overlaps with) the coordinate region of the screen, then the graphic object is rendered in connection with the rendering of the data frame with which the graphic object is associated (e.g., the data frame from which the graphic object is obtained).

Returning to process 100 of FIG. 1, a second approach for determining whether the graphic object is outside the visible area is described.

According to the second approach, determining whether the graphic object is outside a visible area comprises determining one or more maximum coordinate values and/or one or more minimum coordinate values corresponding to a graphic object. For example, with respect to a mapping of the graphic object onto Cartesian coordinates, a maximum coordinate value of the graphic object with respect to a y-axis is determined, and a maximum coordinate value of the graphic object with respect to an x-axis is determined. A maximum coordinate value of the graphic object with respect to the y-axis can correspond to a coordinate associated with a part of the graphic object that has the highest y-axis coordinate, and a maximum value of the graphic object with respect to the x-axis can correspond to a coordinate associated with a part of the graphic object that has the highest x-axis coordinate. As another example, with respect to a mapping of the graphic object onto Cartesian coordinates, a minimum coordinate value of the graphic object with respect to a y-axis is determined, and a minimum coordinate value of the graphic object with respect to an x-axis is determined. A minimum coordinate value of the graphic object with respect to the y-axis can correspond to a coordinate associated with a part of the graphic object that has the lowest y-axis coordinate, and a minimum value of the graphic object with respect to the x-axis can correspond to a coordinate associated with a part of the graphic object that has the lowest x-axis coordinate.

The determining whether the graphic object is outside a visible area can comprise determining one or more maximum coordinate values and/or one or more minimum coordinate values corresponding to a graphic object in relation to coordinate values corresponding to the screen (e.g., a visible area of the screen). For example, the terminal can compare one or more maximum coordinate values and/or one or more minimum coordinate values corresponding to a graphic object to one or more coordinate values corresponding to the screen (e.g., the visible area of the screen). The terminal can determine whether the graphic object is outside a visible area based at least in part on the comparison of one or more maximum coordinate values and/or one or more minimum coordinate values corresponding to a graphic object to one or more coordinate values corresponding to the screen (e.g., the visible area of the screen).

In some embodiments, the maximum coordinate values and minimum coordinate values of the graphic object are determined in geometric space (e.g., a Euclidian space such as using Cartesian coordinates, etc.). The maximum coordinate values and minimum coordinate values of the graphic object can be mapped to the respective pixel space coordinates of a screen. For example, the maximum coordinate values and minimum coordinate values of the graphic object can be mapped onto a geometric space comprising the respective pixel space coordinates of a screen. The graphic object is determined to be outside the visible area of the screen if neither the point corresponding to the mapped maximum coordinate values nor the point corresponding to the mapped minimum coordinate values falls within the coordinate region of the screen.

FIG. 4 is a diagram of maximum coordinates and minimum coordinates of a graphic object according to various embodiments of the present application.

Referring to FIG. 4, graphic object 400 is provided. Graphic object 400 can be determined at least in part in connection with process 100 of FIG. 1 and/or process 500 of FIG. 5. Graphic object 400 can be determined at least in part by device 600 of FIG. 6 and/or computer system 700 of FIG. 7.

As illustrated in FIG. 4, one or more maximum coordinates and one or more minimum coordinates corresponding to graphic object 400 can be determined. Graphic object 400 is mapped to a geometric space and corresponding one or more maximum coordinates and one or more minimum coordinates are determined. The maximum and minimum coordinates on its y-axis respectively correspond to ymax and ymin. The maximum and minimum coordinates on the x-axis respectively correspond to xmax and xmin. After the maximum and minimum coordinates (e.g., on the x-axis and/or the y-axis) are individually mapped to the coordinate region of the screen, the maximum and minimum coordinates become ymax′ and ymin′ and xmax′ and xmin′, respectively (not shown). The mapping of the maximum and minimum coordinates comprises a geometric transformation, including a modeview transformation, a projection transformation, a viewport transformation, and thus obtaining window coordinates The point corresponding to the maximum coordinate values is (xmax′, ymax′), and the point corresponding to the minimum coordinate values is (xmin′, ymin′). If neither of these points is within the coordinate region of the screen, then the graphic object is determined to be outside of the visible area of the screen. If one of these two points falls within the coordinate region of the screen, then the at least part of the graphic object is determined to be within the visible area of the screen.

The mapping of the maximum and minimum coordinates can comprise obtaining coordinates corresponding to the graphic object. In response to obtaining the coordinates corresponding to the graphic object, a modal-view matrix can be determined based at least in part on the coordinates corresponding to the graphic object. In response to determining the model-view matrix, obtaining eye coordinates based at least in part on the model-view matrix. In response to obtaining the coordinates, determining a projection matrix based at least in part on the eye coordinates. In response to determining the projection matrix, obtaining clip coordinates based at least in part on the projection matrix. In response to obtaining the clip coordinates, determining a perspective division based at least in part on the clip coordinates. In response to determining the perspective division, obtaining normalized device coordinates. In response to obtaining the normalized device coordinates, determining a viewport transformation. In response to determining the viewport transformation, obtaining window coordinates corresponding to the graphic object.

Referring back to process 100 of FIG. 1, at 130, the data frame is rendered without rendering data objects that are determined to be outside the visible area. For example, the terminal excludes graphic objects determined to be outside the visible area of the screen in connection with rendering the data frame. A data object (e.g., the graphic object) that is determined to be outside the visible area is not included in the batch used in connection with batch processing associated with rendering the data frame.

A graphic object outside the visible area of a screen that is rendered is not displayed on the screen. Accordingly, rendering the graphic object that is outside the visible area of the screen is unnecessary. Therefore, the graphic object that is outside the visible area does not need to be subject to batch processing (e.g., adding the graphic object to the batch used in connection with rendering the data frame from which the graphic object is obtained is unnecessary). In contrast, a graphic object that is determined to be entirely within the visible area of the screen, or that is determined to be partially within the visible area of the screen, will be added to a batch. A graphic object determined to be at least partially within the visible area of the screen is to be rendered in connection with the corresponding data frame and thus the graphic object is included in a batch for batch processing. According to various embodiments, graphic objects having a same render state are added to the same batch. As an example, a separate batch can be used for each render state (e.g., a mapping of batches to rendering states corresponds to a 1:1 ratio). As another example, each batch can be used in connection with one or more rendering states, and each graphic object having a certain render state is included in the same batch.

FIG. 5 is a flowchart of a method for batch processing according to various embodiments of the present application.

Referring to FIG. 5, process 500 for batch processing is provided. Process 500 can be implemented in connection with mapping 200 of a bounding box, relationship 300 of FIG. 3A, relationship 350 of FIG. 3B, relationship 370 of FIG. 3C, and/or graphic object 400 of FIG. 4. Process 500 can be implemented in connection with process 100 of FIG. 1. Process 500 can be implemented at least in part by device 600 of FIG. 6 and/or computer system 700 of FIG. 7.

At 510, data objects corresponding to a data frame are obtained. In some embodiments, the data objects corresponding to a data frame to be rendered are obtained. As an example, all the graphic objects corresponding to the data frame to be rendered are obtained. The data objects that are obtained can correspond to one or more graphic objects corresponding to the data frame to be rendered. For example, one or more data objects obtained in connection with the data frame to be rendered correspond to one or more image files. In some embodiments, the terminal determines whether the bounding box is outside the visible area of the screen. For example, the CPU determines whether the bounding box corresponding to each of the obtained graphic objects corresponding to a data frame is entirely outside the visible area of the screen.

According to various embodiments, 520 is performed for each data object (e.g., graphic object) corresponding to the data frame to be rendered (e.g., that is obtained at 510).

At 520, a bounding box corresponding to the data object is determined. In some embodiments, for each graphic object that is obtained at 510, a corresponding bounding box is determined. The terminal can determine the bounding box corresponding to the graphic object in response to obtaining the graphic object.

According to various embodiments, the terminal can determine the bounding box corresponding to the graphic object, and use the bounding box in connection with determining whether the graphic object is outside the visible area of a screen.

The bounding box of a graphic object can be determined based at least in part on the graphic data comprised in the graphic object. The determining of a bounding box corresponding to a graphic object comprises using a slightly larger geometric figure that has simple characteristics to provide an approximate substitute for a complex geometric object. For example, the bounding box is determined according to a predetermined shape, and the size of the predetermined shape is determined based at least in part on the size of the corresponding graphic object. The bounding box entirely encompasses the region of the graphic object. According to various embodiments, shapes to which the bounding box can correspond include, without limitation, bounding rectangles, bounding circles, and bounding triangles. Other shapes can be used for a bounding box. Bounding cubes or bounding spheres can be used for three-dimensional space.

According to various embodiments, the bounding box is determined to be a box (or other predetermined shape) having a minimum size while encompassing the corresponding graphic object. The terminal can determine one or more dimensions of the graphic object in connection with determining the corresponding bounding box. For example, the terminal can determine a height (e.g., length) and width of the graphic object.

According to various embodiments, graphic objects are expressed in a geometric space coordinate system or can be mapped to a geometric space coordinate system based on information pertaining to the graphic object (e.g., a size, a shape, a location, etc.). As an example of a bounding rectangle in the coordinate system of a geometric space, the left and right sides of the rectangle are parallel to the y-axis, and the top and bottom sides are parallel to the x-axis. The bounding rectangle can take the form of a minimum bounding rectangle for a graphic object. FIG. 2 illustrates an example of a bounding box for a graphic object (e.g., a graphic object having an irregular geometric figure). According to various embodiments, the bounding box corresponding to a graphic object is determined as described in connection with FIG. 2.

At 530, it is determined whether the data object is within the visible area of a screen based at least in part on the corresponding bounding box. The terminal can determine whether the graphic object is within the visible area of the screen based on the corresponding bounding box in response to determining the bounding box.

In response to determining that the graphic object is outside (e.g., not within) the visible area of a screen at 530, process 500 proceeds to 570. In response to determining that the graphic object is within the visible area of a screen at 530, process 500 proceeds to 540.

According to various embodiments, a bounding box is determined and the determining whether a graphic object is within the visible area of the screen based at least in part on the bounding box is performed as discussed above in connection with process 100 of FIG. 1 (e.g., at 120 of process 100).

According to various embodiments, determining the respective bounding box corresponding to the graphic object and determining whether the graphic object is outside the visible area of a screen is performed for each graphic object (e.g., obtained in connection with the data frame to be rendered). For example, the determining of whether the graphic object is outside the visible area of a screen is performed for each graphic, and can be performed for a plurality of graphic objects contemporaneously. The determining of the bounding box and the determining whether the graphic object is outside the visible area of a screen can be performed with respect to a plurality of graphic objects serially or in parallel. In some embodiments, 540 is performed in connection with one or more graphic objects that are determined to be within the visible area of the screen or determined to be partially within the visible area of the screen. For example, 540 is performed for each of the one or more graphic objects that are determined to be entirely within the visible area of the screen or determined to be partially within the visible area of the screen.

According to various embodiments, the terminal identifies (e.g., determines) a batch to which the graphic object is to be added. For example, the terminal identifies a batch that matches the graphic object. The terminal can determine the batch to which the graphic object is to be added based at least in part on a rendering state of the graphic object.

At 540, a determination of whether a batch corresponds to a rendering state associated with the graphic object is performed. In some embodiments, the terminal determines whether there is an existing batch that matches the rendering state of the graphic object.

As an example, the batch can be determined to correspond to the rendering state associated with the graphic object based at least in part on an indication of one or more rendering states associated with the batch. In some embodiments, the indication of the one or more rendering states associated with the batch can be comprised in metadata for the batch. In some embodiments, the indication of the one or more rendering states associated with the batch is stored in a mapping of rendering states to batches. The mapping of rendering states to batches can be stored locally at the terminal (e.g., in local storage of the terminal) or remotely (e.g., at a data repository that is accessible via a network such as at a server).

As another example, the batch can be determined to correspond to the rendering state associated with the graphic object based at least in part on one or more graphic objects associated with (e.g., comprised in) the batch. The terminal can determine the rendering state associated with the batch based at least in part on the one or more rendering states of one or more graphic objects (already) in the batch.

In some embodiments, the terminal determines whether a batch corresponds to a rendering state associated with the graphic object in connection with determining whether to add the graphic object to the batch.

In some embodiments, the terminal determines whether a batch matching the rendering state of the graphic object currently exists. The terminal can add the graphic object to such a determined batch.

In response to determining that the batch corresponds to a rendering state associated with the graphic object at 540, process 500 proceeds to 550. Conversely, in response to determining that the batch does not correspond to a rendering state associated with the graphic object at 540, process 500 proceeds to 560.

At 550, the graphic object is added to the batch. In response to determining that the batch corresponds to the rendering state of the graphic object, the terminal adds the graphic object to the batch. Adding the graphic object to the batch can comprise associating the graphic object with the batch. For example, the terminal can map an identifier associated with the graphic object to the batch. In response to adding the graphic object to the batch at 550, process 500 proceeds to 570.

In some embodiments, graphic objects that have the same render state are placed in the same batch. Accordingly, in connection with the rendering (e.g., processed by the GPU), the same render state can be used to render the graphic objects in a batch. For example, all graphic objects in a batch can be rendered using the same rendering state. Accordingly, the terminal (e.g., the GPU) can render the graphic objects in the batch without having to frequently switch rendering states. The impact of rendering the data frame or the graphic objects in the batch on performance (e.g., of the GPU and/or CPU) is reduced at least because the graphic objects in the batch can be rendered without the terminal having to frequently switch rendering states. Switch rendering states can cause a CPU and GPU to store an old value and a load new register value, and a RAM has to load new value. If an object is determined to be outside an area (e.g., outside the visible area of the screen), the object does not need to be rendered, which causes less rendering state switching when objects to be rendered are rendered. Further, rendering efficiency is improved at least because switching rendering states is very time-consuming.

At 560 a new batch is created. In some embodiments, a new batch is created in response to determining that the batch does not correspond to a rendering state associated with the graphic object. The terminal can create the new batch in response to determining that the terminal does not currently have a batch that matches the rendering state of the graphic object. The new batch can be associated with the rendering state of the graphic object. In response to creating the batch, the graphic object is added to (e.g., included in) the new batch.

At 570, a determination of whether any graphic objects exist for which 520-560 has not been performed and that correspond to the data frame from which the one or more graphic objects are obtained at 510 is performed. For example, the terminal determines whether any graphic objects that were obtained at 510 remain to be processed via 520-560.

In response to determining that no graphic objects remain to be processed via 520-560 at 570, the process proceeds to 580.

In response to determining that one or more graphic objects remain to be processed via 520-560 at 570, the process proceeds to 590 at which a next graphic object is selected and is used in connection with 520-560. For example, process 500 returns to 520 with respect to a next graphic object.

When all the graphic objects in the data frame have been checked, all the batches for the corresponding data frame have been created. The graphic objects comprised in all the corresponding batches are graphic objects within the visible area of a screen or partially within the visible area of a screen. In some embodiments, the graphic objects in each batch have the same rendering state.

At 580, one or more graphic objects are rendered. The terminal can render each of the graphic objects in one or more batches corresponding to the data frame. For example, the one or more batches corresponding to the data frame are provided to the GPU. In response to receiving the one or more batches, the GPU can render the one or more graphic objects in each of the one or more batches. In some embodiments, all batches corresponding to the data frame to be rendered are processed to render the corresponding graphic objects in each of the batches.

Process 500 can be implemented by (e.g., processed by) a CPU. At 580, a CPU can request from the GPU display memory space to be occupied by all the batches. The CPU can transfer all the batches into the display memory space, and the GPU carries out batch rendering of the graphic objects in each batch.

According to various embodiments, the created batches are submitted to the GPU after complete processing of one data frame. Other approaches for triggering (e.g., causing) batch submission can be implemented. For example, a batch submission can be triggered in response to a determination that the graphic objects in a batch reach a set volume limit (e.g., a preset threshold limit). As another example, batch submissions are cyclical according to a preset threshold time. For example, the created batches are submitted after a certain length of time. In addition to accommodating the graphic objects in one data frame, one batch may also accommodate graphic objects in different data frames.

An application or other process running on the terminal can implement batch rendering. In some embodiments, a functional unit such as an add-on in an application or a software development kit (SDK) implements the batch rendering. The application can be a system-level application or a user-level application. In some embodiments, an application or other process located on a server implements the batch rendering. Embodiments of the present invention impose no particular restrictions in this regard.

FIG. 6 is a structural diagram of a device according to various embodiments of the present application.

Referring to FIG. 6, device 600 for batch processing is provided. Device 600 can be implemented in connection with mapping 200 of a bounding box, relationship 300 of FIG. 3A, relationship 350 of FIG. 3B, relationship 370 of FIG. 3C, and/or graphic object 400 of FIG. 4. Device 600 can implement at least part of process 100 of FIG. 1 and/or process 500 of FIG. 5. Device 600 can be implemented at least in part by computer system 700 of FIG. 7.

Device 600 comprises acquiring module 610, assessing module 620, and batch processing module 630. Device 600 can further comprise: submitting module 640.

Acquiring module 610 is configured to obtain all the graphic objects from a data frame that is to be rendered. The graphic objects can comprise graphic data and rendering states. The rendering states can include, but are not limited to, color rendering states, fill states, anti-aliasing states, texture perspective states, shading states, fog states, and smoothness states.

Assessing module 620 is configured to determine whether a graphic object is outside the visible area of the screen. For example, the assessing module 620 can determine, for each graphic object obtained by the acquiring module 610, whether the graphic object is outside the visible area of a screen.

In some embodiments, assessing module 620 individually determines the bounding box of each graphic object and individually determines whether the corresponding graphic object is outside the visible area of a screen based at least in part on the bounding box.

In connection with determining (for each graphic object) whether the graphic object is outside the visible area of the screen, the coordinates of the graphic object bounding box in geometric space can be mapped to the pixel space coordinates of a screen. If none of the mapped bounding box coordinates falls within the coordinate region of the screen, the assessing module 620 determines that the graphic object is outside of the visible area of the screen.

In some embodiments, assessing module 620 determines whether a graphic object is outside the visible area of the screen based at least in part on maximum coordinate values and/or minimum coordinate values corresponding to the graphic object.

Assessing module 620 determines the maximum coordinate values and minimum coordinate values of a graphic object in geometric space. Assessing module 620 can map the maximum coordinate values and minimum coordinate values to pixel space coordinates of the screen. If neither the point corresponding to the mapped maximum coordinate values nor the point corresponding to the mapped minimum coordinate values falls within the coordinate area of the screen, then the graphic object is determined to be outside the visible area of the screen.

Batch processing module 630 is configured to render graphic objects that are within (or partially within) the visible area of the screen and to exclude graphic objects that are outside the visible area of a screen from rendering. Batch processing module 630 can determine whether to include a graphic object in a batch for rendering based on whether the graphic object is within (or outside) the visible area of the screen. If the currently checked graphic object is determined to be outside the visible area of the screen, then batch processing module 630 continues to the next graphic object; otherwise, batch processing module 630 adds the currently checked graphic object to a batch.

Batch processing module 630 can determine whether the graphic object matches a batch (e.g., an existing batch) in connection with adding the currently checked graphic object to a batch. For example, batch processing module 630 can determine whether a rendering state corresponding to the batch is the same as the rendering state of the graphic object. If the graphic object matches the batch, the batch processing module 630 adds the currently checked graphic object into the batch of graphic objects (e.g., which share the same render state as the graphic object being added to the batch); otherwise, the batch processing module 630 creates a new batch and puts the currently checked graphic object into the new batch.

In response to determining that all graphic objects that were obtained from the data frame to be rendered have been processed in relation to determining whether the graphic objects fall within the visible area of the screen and adding the graphic objects that are within (or partially within) the visible area of the screen to corresponding batches, the batches corresponding to the data frame to be rendered can be rendered. For example, the graphic objects comprised batches corresponding to the data frame to be rendered can be rendered.

Submitting module 640 can be configured to submit each batch that was created to a GPU so that the GPU can batch render the graphic objects in each batch. Submitting module 640 can first request from the GPU display memory space to be occupied by all the batches. Submitting module 640 can then transfer all the batches into the display memory space, and the GPU carries out batch rendering of the graphic objects in each batch.

FIG. 7 is a functional diagram of a computer system for batch processing according to various embodiments of the present application.

Referring to FIG. 7, computer system 700 for batch processing is provided. Computer system 700 can be implemented in connection with mapping 200 of a bounding box, relationship 300 of FIG. 3A, relationship 350 of FIG. 3B, relationship 370 of FIG. 3C, and/or graphic object 400 of FIG. 4. Computer system 700 can implement at least part of process 100 of FIG. 1 and/or process 500 of FIG. 5. Computer system 700 can be implemented at least in part by device 600 of FIG. 6.

Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718).

Processor 702 is coupled bi-directionally with memory 710, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data, and objects used by the processor 702 to perform its functions (e.g., programmed instructions). For example, memory 710 can include any suitable computer-readable storage media, described below, depending on whether, for example, data access needs to be bi-directional or uni-directional. For example, processor 702 can also directly and very rapidly retrieve and store frequently needed data in a cache memory (not shown). The memory can be a non-transitory computer-readable storage medium.

A removable mass storage device 712 provides additional data storage capacity for the computer system 700, and is coupled either bi-directionally (read/write) or uni-directionally (read only) to processor 702. For example, storage 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storage device 712 and fixed mass storage 720 generally store additional programming instructions, data, and the like that typically are not in active use by the processor 702. It will be appreciated that the information retained within mass storage device 712 and fixed mass storage 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

The above method, means, and device provided by the present invention may be applied to a graphic engine in a user terminal system layer and, for example, be responsible for painting system-level operating interface graphics. Or they may be applied to a graphic engine in a user terminal app layer and, for example, be responsible for painting app-level interface graphics.

Please understand that, in several embodiments provided by the present invention, the disclosed means and method may be implemented in other ways. For example, the device embodiment described above is merely illustrative. For example, the delineation of units is merely a delineation according to local function. The delineation can take a different form during actual implementation.

Units described as separate components may or may not be physically separate, and components displayed as units may or may not be physical units. They can be located in one place, or they can be distributed across multiple network units. The embodiment schemes of the present embodiments can be realized by selecting part or all of the units in accordance with actual need.

In addition, all the functional units in the various embodiments of the present invention could be integrated in a processing unit. Or each unit could physically exist on its own, or two or three or more units could be integrated into one unit. The aforesaid integrated units can take the form of hardware, or they can take the form of hardware combined with software function units.

The units described above, in which the software function units are integrated, can be stored in a computer-readable storage medium. The software function units described above are stored in a storage medium and include a number of instructions whose purpose is to cause a piece of computer equipment (which can be a personal computer, a server, or network computer) or a processor to execute some of the steps in the method described in the various embodiments of the present invention. The storage medium described above encompasses: USB flash drive, mobile hard drive, read-only memory (ROM), random access memory (RAM), magnetic disk, or optical disk, or various other media that can store program code.

The preferred embodiments of the present invention that are described above are merely that and do not limit the present invention. Any modification, equivalent substitution, or improvement that is made in keeping with the spirit and principles of the present invention shall be included within the protective scope of the present invention.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining a plurality of graphic objects associated with a data frame that is to be rendered;
determining whether individual graphic objects in the plurality of graphic objects are outside a visible area of a screen to be displayed; and
rendering graphic objects of the plurality of graphic objects that are determined to be at least partially within the visible area of the screen, and excluding from rendering graphic objects of the plurality graphic objects that are determined to be outside the visible area of the screen.

2. The method of claim 1, the determining whether the individual graphic objects in the plurality of graphic objects are outside the visible area of the screen comprises:
determining one or more bounding boxes corresponding to the plurality of graphic objects; and
determining whether the individual graphic objects in the plurality of graphic objects are outside the visible area of the screen based at least in part on the corresponding one or more bounding boxes.

3. The method of claim 2, wherein the determining whether the individual graphic objects in the plurality of graphic objects are outside the visible area of the screen based at least in part on the corresponding one or more bounding boxes comprises:
mapping coordinates in geometric space corresponding to at least one bounding box that is associated with at least one graphic object to coordinates of a screen in pixel space, the at least one bounding box being selected from the one or more bounding boxes, and the at least one graphic object being selected from the plurality of graphic objects; and
determining that the at least one graphic object is outside the visible area of the screen in response to a determination that none of the coordinates of the at least one bounding box falls within a coordinate region of the screen.

4. The method of claim 2, wherein the one or more bounding boxes are a square, a rectangle, a circle, or a triangle.

5. The method of claim 2, wherein at least one bounding box of the one or more bounding boxes is selected based on a shape of an image corresponding to graphic data comprised in at least one of the plurality of graphic objects.

6. The method of claim 1, the determining whether the individual graphic objects in the plurality of graphic objects are outside the visible area of the screen comprises:
determining one or more maximum coordinate values and one or more minimum coordinate values of at least one graphic object, the at least one graphic object being selected from the plurality of graphic objects, and the one or more maximum coordinate values and the one or more minimum coordinate values being in geometric space;
mapping the one or more maximum coordinate values and the one or more minimum coordinate values to a respective pixel space coordinates of a screen; and
determining that the at least one graphic object is outside the visible area of the screen in response to a determination that neither a point corresponding to the one or more maximum coordinate values nor a point corresponding to the one or more minimum coordinate values falls within a coordinate region of the screen.

7. The method as described of claim 1, wherein the rendering graphic objects of the plurality of graphic objects that are determined to be at least partially within the visible area of the screen, and excluding from rendering graphic objects of the one more graphic objects that are determined to be outside the visible area of the screen comprises:
adding, to one or more batches, the graphic objects of the plurality of graphic objects that are determined to be at least partially within the visible area of the screen; and
excluding, from the one or more batches, graphic objects of the one more graphic objects that are determined to be outside the visible area of the screen.

8. The method of claim 7, wherein the adding the graphic objects of the plurality of graphic objects that are determined to be at least partially within the visible area of the screen to the one or more batches comprises:
determining whether a batch that is associated with a rendering state that matches a rendering state of the graphic objects of the plurality of graphic objects exists;
in response to determining that the batch that is associated with the rendering state that matches the rendering state of the graphic objects of the plurality of graphic objects does not exist, creating a batch corresponding to the rendering state of the graphic objects of the plurality of graphic objects; and
in response to determining that the batch that is associated with the rendering state that matches the rendering state of the graphic objects of the plurality of graphic objects exists, adding the graphic objects to the batch that is associated with the rendering state that matches the rendering state of the graphic objects.

9. The method of claim 7, wherein the one or more batches are respectively associated with one or more rendering states.

10. The method of claim 7, wherein the graphic objects of the plurality of graphic objects that are respectively added to one of the one or more batches have a same rendering state.

11. The method of claim 7, further comprising:
providing each batch associated with the data frame to be rendered to a graphics processing unit (GPU), wherein the GPU batch renders the graphic objects in each batch.

12. The method of claim 1, wherein the plurality of graphic objects respectively comprise corresponding graphic data and an indication of a corresponding rendering state.

13. The method of claim 12, wherein the determining whether the one or more graphic objects are outside the visible area of the screen to be displayed comprises:
determining whether the individual graphic objects in the plurality of graphic objects are outside the visible area of the screen based at least in part on the graphic data respectively comprised in the plurality of graphic objects.

14. The method of claim 12, wherein the graphic objects of the plurality of graphic objects that are determined to be at least partially within the visible area of the screen are rendered based at least in part on the rendering state respectively comprised in the corresponding plurality of graphic objects.

15. A device, comprising:
one or more processors configured to:
obtain a plurality of graphic objects associated with a data frame that is to be rendered;
determine whether individual graphic objects in the plurality of graphic objects are outside a visible area of a screen to be displayed; and
render graphic objects of the plurality of graphic objects that are determined to be at least partially within the visible area of the screen, and exclude from rendering graphic objects of the plurality of graphic objects that are determined to be outside the visible area of the screen; and
one or more memories coupled to the one or more processors, configured to provide the one or more processors with instructions.

16. The system of claim 15, wherein the one or more processors are configured to:
determine one or more bounding boxes corresponding to the plurality of graphic objects; and
determine whether the individual graphic objects in the plurality of graphic objects are outside the visible area of the screen based at least in part on the corresponding one or more bounding boxes.

17. The system of claim 16, wherein the one or more processors are configured to:
map coordinates in geometric space corresponding to at least one bounding box that is associated with at least one graphic object to coordinates of a screen in pixel space, the at least one bounding box being selected from the one or more bounding boxes, and the at least one graphic object being selected from the plurality of graphic objects; and
determine that the at least one graphic object is outside the visible area of the screen in response to a determination that none of the coordinates of the at least one bounding box falls within a coordinate region of the screen.

18. The system of claim 15, wherein the one or more processors are configured to:
determine one or more maximum coordinate values and one or more minimum coordinate values of at least one graphic object, the at least one graphic object being selected from the plurality of graphic objects, and the one or more maximum coordinate values and the one or more minimum coordinate values being in geometric space;
map the one or more maximum coordinate values and the one or more minimum coordinate values to a respective pixel space coordinates of a screen; and
determine that the at least one graphic object is outside the visible area of the screen in response to a determination that neither a point corresponding to the one or more maximum coordinate values nor a point corresponding to the one or more minimum coordinate values falls within a coordinate region of the screen.

19. The system of claim 15, wherein the one or more processors are configured to:
add, to one or more batches, the graphic objects of the plurality of graphic objects that are determined to be at least partially within the visible area of the screen; and
exclude, from the one or more batches, graphic objects of the one more graphic objects that are determined to be outside the visible area of the screen.

20. A computer program product, the computer program product being embodied in a non-transitory computer readable storage medium and comprising computer instructions for:
obtaining a plurality of graphic objects associated with a data frame that is to be rendered;
determining whether individual graphic objects in the plurality of graphic objects are outside a visible area of a screen to be displayed; and
rendering graphic objects of the plurality of graphic objects that are determined to be at least partially within the visible area of the screen, and excluding from rendering graphic objects of the plurality of graphic objects that are determined to be outside the visible area of the screen.
